(19) United States
(12) Patent Application Publication
(10) Pub. No.: US 2004/0062176 A1
(43) Pub. Date: Apr. 1, 2004

(54) Cartridge holder with a cartridge opening mechanism

(76) Inventors: Ruey-Lin Liang, Changhua Hsien (TW); Yu-Hsiu Chang, Changhua Hsien (TW)

Correspondence Address: J.C. Patents, Suite 250, 4 Venture, Irvine, CA, 92618, US

(21) Appl. No.: 10/666,339

(22) Filed: Sep. 18, 2003

Related U.S. Application Data
(63) Continuation-in-part of application No. 09/494,179, filed on Jan. 31, 2000, now abandoned.

(30) Foreign Application Priority Data
Nov. 17, 1999 (TW) 88120009

(51) Int. Cl. G11B 33/02

(52) U.S. Cl. 369/77.2

(57) ABSTRACT

Only a pivot arm and a torsion spring are employed to open a shutter of a cartridge. Hence, a structure of a cartridge holder with such a cartridge opening mechanism is much simpler than the prior art. The pivot arm is employed to open the cartridge shutter when the cartridge is inserted into the cartridge holder. The torsion spring provides a restoring force to return the pivot arm back to a closed position when the cartridge is ejected. Adverse effects, which are generated during a rotation of a disc in the prior art cartridge opening mechanism, can be eliminated.

### CROSS-REFERENCE TO RELATED APPLICATION

This application is a continuation-in-part of a prior application Ser. No. 09/494,179, filed Jan. 31, 1999. The prior application Ser. No. 09/494,179 claims the priority benefit of Taiwan application serial no. 88120009, filed on Nov. 17, 1999.

### BACKGROUND OF THE INVENTION

1. Field of the Invention

The present invention relates to a cartridge opening mechanism. More particularly, the present invention relates to a cartridge holder with a cartridge opening mechanism, in which a pivot arm and a torsion spring are disposed on a cartridge holder body of the cartridge holder to open a shutter of a cartridge.

2. Description of Related Art

In 1997, the DVD Alliance published a DVD-RAM standard in which a disc with a cartridge is revealed. Such disc has a read-and-write feature and a larger memory than a typical CD. Hence, the DVD-RAM is expected to be a future trend in the disc player industry. By considering the acceptability of the market, a future DVD-RAM disc player should read a disc both with and without a cartridge.

In order for a disc player to read a disc with a cartridge according to the DVD-RAM standard, a cartridge opening mechanism, which mechanism opens a cartridge shutter, has to be designed in the disc player. In 1998, Hitachi and Panasonic, respectively, announced a DVD-RAM disc player which can read a cartridge disc.

Reference is made to FIG. 1, which illustrates a schematic diagram of a disc with a cartridge. A disc is enclosed in a cartridge 10, which protects the disc from the outside environment. However, in order to read data stored in the disc, a movable shutter 20 is designed. When the shutter 20 is opened, a portion of the disc is exposed and the stored data can be read from the disc. The shutter 20 includes a protrusion 30. The cartridge opening mechanism comes into contact with an edge of the protrusion 30, and the shutter 20 is then pushed to open and the disc is exposed.

Reference is made to FIG. 2, which illustrates a schematic, top view diagram of a prior art cartridge opening mechanism disposed on a clutching plate. A prior art cartridge opening mechanism 60 is disposed on a clutching plate 40. Such clutching plate 40 is located above a cartridge holder body (not shown) and does not move with the cartridge holder body. The clutching plate 40 includes a pressing mechanism 50 and the cartridge opening mechanism 60. Such opening mechanism 60 is constructed by defining curved slots 62 on the clutching plate 40. An end of a pivot rod 64 is secured on a surface of the clutching plate 40. Restricted devices 66 are on another surface of the clutching plate 40, which restrict the pivot rod 64 to rotate within the curved slots 62 in a circular rotation. An extension spring 68 is employed to provide a restoring force, which returns the pivot rod 64 back to its original position in the absence of the cartridge 10.

The prior art cartridge opening mechanisms described above have many drawbacks. For example, because the prior art cartridge opening mechanism is installed on the clutching plate, such installation requires a slot formation on the clutching plate. Although, no problems arise when a disc with a cartridge is read, reading a disc without a cartridge generates air whirlpools during a rotation of the disc. Vibration and noise is then generated. Even a rotating speed of the disc may be affected. A spindle motor can be slowed down, and hence, a data transmission speed is reduced or errors may occur during a read or write procedure.

Moreover, the prior art cartridge opening mechanism constitutes many parts and the assembly process is very complicated. These increase both the production cost and time.

### SUMMARY OF THE INVENTION

The present invention provides a cartridge holder with a cartridge opening mechanism, in which only a pivot arm and a torsion spring, as an example, are employed to open a shutter of a cartridge. The structure of the cartridge holder with the cartridge opening mechanism is much simpler than the prior art described above.

The present invention provides a cartridge holder with a cartridge opening mechanism, in which a pivot arm is employed to open a shutter of a cartridge inserted in the cartridge holder. A torsion spring, as an example, is employed to provide a restoring force to return the pivot arm back to a closed position when the cartridge is ejected.

The present invention provides a cartridge holder with a cartridge opening mechanism. The opening mechanism is disposed on a cartridge holder body of the cartridge holder. Therefore, no slot openings are required in a clutching plate as in the prior art. Adverse effects, such as vibration or air whirlpools, which are generated during a rotation of a disc in the prior art cartridge opening mechanism, can be resolved. The production cost can be reduced.

The present invention provides a cartridge holder with a cartridge opening mechanism that comprises a cartridge holder body, with an opening for receiving a cartridge located in a side of the cartridge holder body. A first hinge shaft structure is disposed on another side of the cartridge holder body and away from the opening. A pivot arm is used to open and close a cartridge shutter. A first end of the pivot arm constitutes a second hinge shaft structure, which interlocks with the first hinge shaft structure to allow a rotation of the pivot arm. A second end of the pivot arm is in a closed position and comes into contact with an edge of a protrusion on the cartridge shutter while the second end of the pivot arm is pushed by the cartridge to an open position in which the cartridge shutter is opened. An elastic device, part of which elastic device is secured to the cartridge holder body and another part of which elastic device is secured to the pivot arm, provides a restoring force to return the pivot arm from the open position back to the closed position in the absence of the cartridge.

### BRIEF DESCRIPTION OF DRAWINGS

The accompanying drawings are included to provide a further understanding of the present invention, and are incorporated in and constitute a part of this specification. The drawings illustrate embodiments of the present invention and, together with the description, serve to explain the principles of the present invention. In the drawings,

FIG. 1 is a schematic diagram of a disc with a cartridge;

FIG. 2 is a schematic, top view showing a prior art cartridge opening mechanism disposed on a clutching plate;

FIGS. 3A to 3C are schematic, perspective views showing individual parts of a cartridge holder with a cartridge opening mechanism in accordance with a preferred embodiment of the present invention;

FIG. 4 is a schematic, perspective view illustrating connections of individual parts of a cartridge holder with a cartridge opening mechanism in accordance with a preferred embodiment of the present invention;

FIG. 5 is a schematic, perspective view of a cartridge holder with a cartridge opening mechanism in accordance with a preferred embodiment of the present invention;

FIG. 6 is a schematic, top view showing a cartridge received in a cartridge holder with a cartridge opening mechanism in accordance with a preferred embodiment of the present invention;

FIG. 7 is a schematic, perspective view of a cartridge holder for receiving a disc without a cartridge in accordance with a preferred embodiment of the present invention; and

FIG. 8 is a schematic, top view showing a disc without a cartridge received in a cartridge holder with a fixed cartridge opening mechanism in accordance with a preferred embodiment of the present invention.

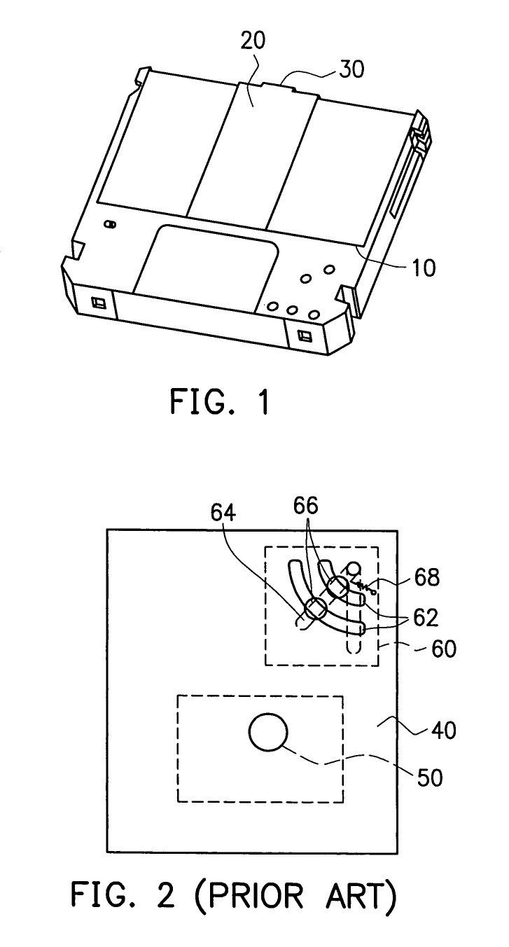

### DETAILED DESCRIPTION OF PREFERRED EMBODIMENTS

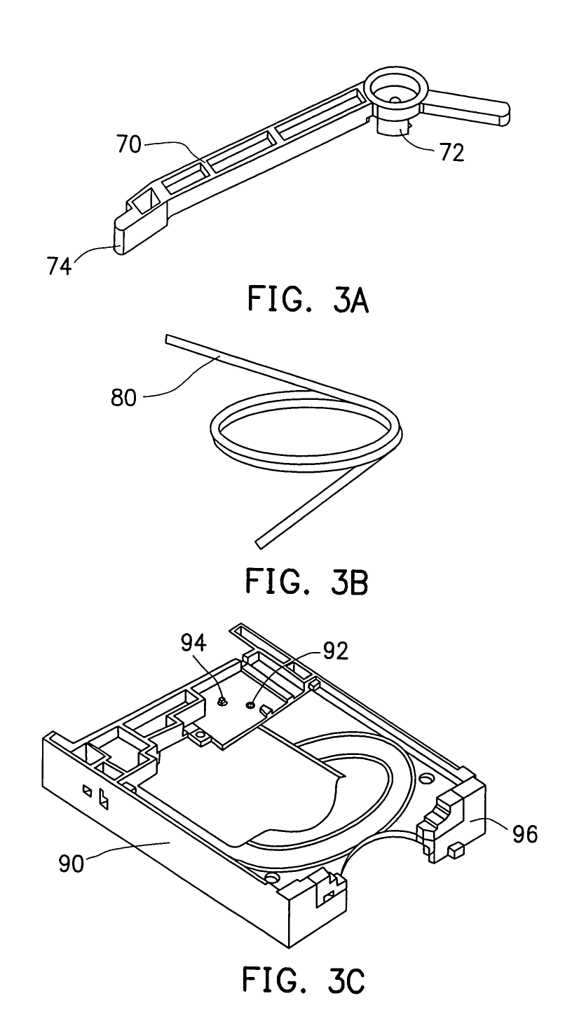

Reference is made to FIGS. 3A to 3C, which are schematic, perspective views showing individual parts of a cartridge holder with a cartridge opening mechanism in accordance with a preferred embodiment of the present invention. The cartridge holder with the cartridge opening mechanism includes a cartridge holder body 90, a pivot arm 70, and a torsion spring 80.

The cartridge holder body 90 shown in FIG. 3C can receive a disc with or without a cartridge. One side of the cartridge holder 90 has an opening 96, into which the disc with or without the cartridge is inserted. A first hinge shaft structure 92 is disposed on another side of the cartridge holder body 90 away from the opening 96.

The pivot arm 70 shown in FIG. 3A includes a second hinge shaft structure 72 that interlocks with the first hinge shaft structure of the cartridge holder body 90. This allows a rotation of the pivot arm 70. The second end of the pivot arm 70 includes a protruding point 74 that comes into contact with an edge of a protrusion on a shutter of the disc with the cartridge.

The torsion spring 80 shown in FIG. 3B is an example of an elastic device in accordance with the preferred embodiment of the present invention. An end of the torsion spring 80 is secured to the cartridge holder body 90 and a second end of the torsion spring 80 is secured to the pivot arm 70.

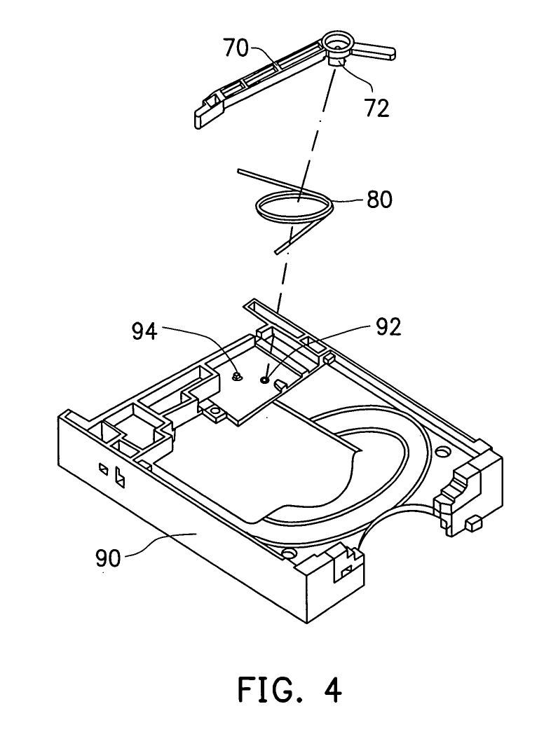

Reference is made to FIG. 4, which illustrates a schematic view showing connections of individual parts of a cartridge holder with a cartridge opening mechanism in accordance with the preferred embodiment of the present invention. The first hinge shaft structure 92 is encased in a circular coil portion of the torsion spring 80. The end of the torsion spring 80 is secured to a hooked structure 94 of the cartridge holder body 90. The second hinge shaft structure 72 of the pivot arm 70 is then interlocked with the first hinge shaft structure 92. Finally, the other end of the torsion spring 80 is secured to the pivot arm 70.

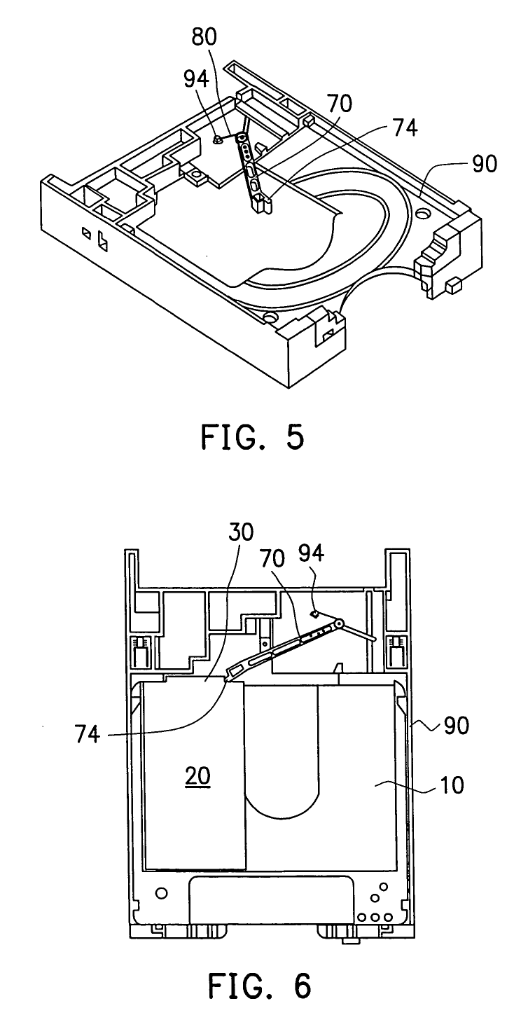

Reference is made to FIG. 5, which illustrates a schematic, perspective view of a cartridge holder with a cartridge opening mechanism in accordance with the preferred embodiment of the present invention. Therein, the pivot arm 70 is shown in a closed position.

Reference is made to FIG. 6, which illustrates a schematic top view of a cartridge inserted into a cartridge holder with a cartridge opening mechanism in accordance with the preferred embodiment of the present invention. A cartridge 10 is inserted into the cartridge holder body 90. Before the cartridge 10 comes into contact with the pivot arm 70, the pivot arm 70 is in the closed position. Further insertion of the cartridge 10 makes the protruding point 74 of the pivot arm 70 come into contact with an edge of a protrusion 30 on a shutter 20 of the cartridge 10. Inserting the cartridge 10 into the cartridge holder body 90 pushes the pivot arm 70 to an open position. In this instant, the protruding point 74 of the pivot arm 70 opens the shutter 20 of the cartridge 10. When the cartridge 10 is ejected from the cartridge holder body 90, a restoring force is provided by the torsion spring 80, which returns the pivot arm 70 back to the closed position.

The torsion spring described above can be replaced by an extension spring, a compression spring, or other elastic devices which achieve the same function provided by the torsion spring.

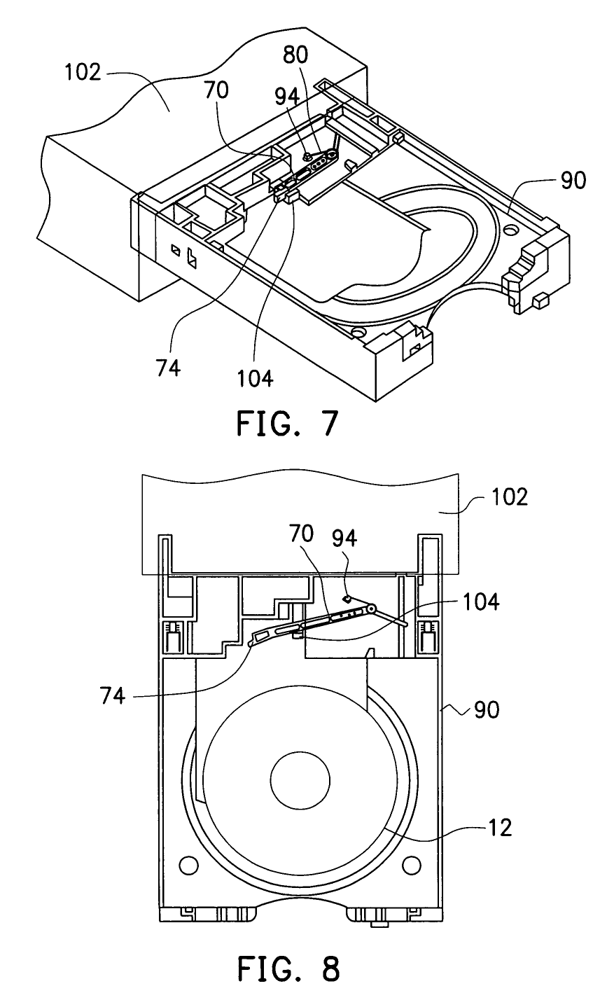

Reference is made to FIG. 7, which illustrates a schematic, perspective view of a cartridge holder for receiving a disc without a cartridge in accordance with the preferred embodiment of the present invention. Therein, the pivot arm 70 is fixed in a position by a blocker 104 when the cartridge holder body 90 is outside of the disc player 102.

Reference is made to FIG. 8, which illustrates a schematic top view of a disc without a cartridge inserted into a cartridge holder with a fixed cartridge opening mechanism in accordance with the preferred embodiment of the present invention. A disc without a cartridge 12 is inserted into the cartridge holder body 90. Before the disc without a cartridge 12 is inserted, the pivot arm 70 is fixed in a position. Thus after the insertion of the disc without a cartridge 12, the pivot arm 70 does not contact with the disc without a cartridge 10. When the disc of a cartridge 12 is ejected from the cartridge holder body 90, the pivot arm 70 is released from the blocked position, and a restoring force is provided by the torsion spring 80, which returns the pivot arm 70 back to the closed position.

Accordingly, the present invention provides a cartridge holder with a cartridge opening mechanism, in which only a pivot arm and a torsion spring, as an example, are employed to open a shutter of a cartridge. The structure of the cartridge holder with the cartridge opening mechanism is much simpler than the prior art described above.

Another advantage of the cartridge holder with the cartridge opening mechanism in accordance with a preferred embodiment of the present invention is that a pivot arm is employed to open a shutter of a cartridge inserted into the cartridge holder. A torsion spring, as an example, is employed to provide a restoring force to return the pivot arm back to a closed position when the cartridge is ejected.

Yet another advantage of the cartridge holder with the cartridge opening mechanism in accordance with a preferred embodiment of the present invention is that the opening mechanism is disposed on a cartridge holder body of the cartridge holder. Therefore, no slot openings are required in the clutching plate as in the prior art. Adverse effects, such as vibration or air whirlpools, which are generated during a rotation of a disc in the prior art cartridge opening mechanism, can be eliminated.

The present invention has been described using exemplary preferred embodiments. However, it is to be understood that the scope of the present invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A cartridge holder for receiving a cartridge or a disc without a cartridge, in which the cartridge holder having a cartridge opening mechanism for opening a shutter of a cartridge, comprising:
a cartridge holder body, with an opening located on a side of the cartridge holder body, which opening receives the cartridge and the disc without a cartridge, and a first hinge shaft structure disposed on another side of the cartridge holder body away from the opening;
a pivot arm, wherein the pivot arm is mounted on the same surface of the cartridge holder body for receiving the cartridge, wherein a first end of the pivot arm constitutes a second hinge shaft structure, which second hinge shaft structure interlocks with the first hinge shaft structure to allow a rotation of the pivot arm, such that when a second end of the pivot arm is in an closed position and comes into contact with an edge of a protrusion on a cartridge shutter, the first end of the pivot arm is pushed by the cartridge to an open position in which the cartridge shutter is open; and
an elastic device, with a part of the elastic device secured to the cartridge holder body and another part of the elastic device secured to the pivot arm, wherein the elastic device provides a restoring force to return the pivot arm from the open position back to the closed position in the absence of the cartridge.

2. The cartridge holder with the cartridge opening mechanism of claim 1, wherein the cartridge holder body includes a hooked structure to secure the part of the elastic device.

3. The cartridge holder with the cartridge opening mechanism of claim 1, wherein the end of the pivot arm includes an protruding point that comes into contact with the edge of the protrusion on the shutter.

4. The cartridge holder with the cartridge opening mechanism of claim 1, wherein the elastic device includes a torsion spring.

5. The cartridge holder with the cartridge opening mechanism of claim 1, wherein the elastic device includes an extension spring.

6. The cartridge holder with the cartridge opening mechanism of claim 1, wherein the elastic device includes a compression spring.
